(19) United States
(12) Patent Application Publication
(10) Pub. No.: US 2003/0208427 A1
(43) Pub. Date: Nov. 6, 2003

(54) Automated investment advisory software and method

(76) Inventors: Dirk Peters, Miami, FL (US); Eric Weiss, Miami, FL (US)

Correspondence Address: Lisa J Ulrich, Darby & Darby, 805 Third Avenue, New York, NY, 10022-7513, US

(21) Appl. No.: 10/070,344

(22) PCT Filed: Dec. 13, 2000
(86) PCT No.: PCT/US00/33740

(51) Int. Cl. G06F 17/60

(52) U.S. Cl. 705/36; 705/38

(57) ABSTRACT

A web-based investment advisory system and method to assist financial advisors in delivering personalized investment advisory services to investors. An advisor assesses a client's investment profile (112) for evaluating the risk dimensions of the client's current portfolio holdings (118), compares investment risks classification based upon portfolio holdings (122), recommends specific portfolio changes (132) based on asset classes to create an optimized portfolio for the client's investment profile and suggests specific investment products available through the advisor and integrates with the advisors trading platform for executing purchase and sales orders (134).

### CROSS-REFERENCE TO RELATED APPLICATION

This application claims priority from U.S. Patent Application No. 60/170,365, entitled “Optimize Online Portfolio Valuation,” filed on Dec. 13, 1999, the disclosure of which is hereby incorporated by reference in its entirety.

### BACKGROUND OF THE INVENTION

1. Field of the Invention

The invention relates generally to the field of investment advisory services. More particularly, the invention relates to a computer-implemented system and method that assists advisors in delivering personalized investment advisory services, including risk assessment, portfolio evaluation and portfolio construction, through an interface customized by the advisor to meet its particular market, product and client needs.

2. Description of Related Art

Throughout the world, demand for investment advisory services has increased dramatically as investors are faced with exponential growth in the number of financial products available and the quantity of investment information distributed through both new and traditional media. In addition, in many markets outside of the U.S., globalization and the concurrent relaxation of regulations pertaining to cross-border investing permit investors to invest outside of their own countries for the first time. Meanwhile, newly structured pension systems in many countries now require individuals to choose and manage their own retirement assets, a daunting task for many neophyte investors. These global trends significantly increase the complexity of making investment decisions, resulting in strong global demand for personalized-investment advisory services.

In response to this increased demand, financial intermediaries of all shapes and sizes including, but not limited to, securities brokers, web-based finance sites, independent investment advisors and banks now provide investment advisory services. In an increasingly common approach, these intermediaries (collectively called “advisors”) utilize asset allocation methodologies, in many cases using commercial portfolio optimization software, to recommend specific market segment or “asset class” allocations for their clients. These recommendations are typically based on an assessment of the client's investment goals, time horizon, risk profile and current investment portfolio.

Once an advisor has identified the asset allocation, the advisor then recommends specific investment products, many times in the form of mutual funds, to create an optimized portfolio for the client. The advisor then purchases the investment products directly or through a third-party. Thereafter, the advisor oversees the client's investment portfolio, reporting balances and holdings to the client usually on a monthly basis, and re-balances the portfolio when needed to adjust it to the agreed upon allocation.

A number of software applications have been developed in recent years to assist advisors in assessing client investment profiles, evaluating portfolio risk and “optimizing” client portfolios to the desired asset allocation. One longstanding method that has demonstrated success as a portfolio management tool is the mean-variance optimization procedure developed by Dr. Harold Markowitz in the 1950's. Many programs use Dr. Markowitz's method, or some variation of it, to help advisors structure “optimal” portfolios for their clients.

Dr. Markowitz's method assumes investment returns follow a multi-variate probability distribution with a finite expected value vector and a covariant matrix. Dr. Markowitz's method bases this assumption on investment returns which are in an array of asset classes over a given fixed time period. The method then seeks to combine the asset classes in linear combination so as to achieve the singly-dimensioned probability distribution of investment returns with the maximum expected value for a given standard deviation (or the minimum standard deviation for a given expected value). The method of optimization is known as quadratic programming. Dr. Markowitz originated a quadratic programming algorithm to solve this mean-variance optimization problem, but other quadratic programming algorithms can also be utilized.

The algorithms produce a curve in the plane of expected return vs. standard deviation, consisting of the maximum expected return for each standard deviation. This curve has come to be known as the “efficient frontier,” and the linear combinations of assets representing the points on the frontier are known as “efficient portfolios.”

Given this efficient frontier of investment asset combinations, the conventional method of optimizing a portfolio for a particular investor's risk preference and displaying the risk and return characteristics of alternative portfolios is as follows:

First, a heuristic method is applied to determine the standard deviation of the investment return distribution corresponding to the investor's risk preference. The method frequently employs a questionnaire assessment of the investor's general attitude toward risk, in which the key questions seek to categorize the investor's preferred risk posture in one of the following: “very conservative,” “moderately conservative,” “moderately aggressive,” “aggressive,” “very aggressive,” etc.

Given the standard deviation inferred from the investor's questionnaire response, the point on the efficient frontier having that standard deviation is selected as the optimal portfolio. In the course of the risk preference assessment process, or after the investor's risk preference has been assessed and the optimization procedure has been performed as described above, the investor is shown exhibits characterizing the relationship between risk and return. Frequently central among these exhibits is the efficient frontier itself, displayed in the plane of expected return vs. standard deviation. The exhibit is intended to show how expected return increases as risk increases.

However, these applications are limited in several ways. For example, most of these programs are static in that they are PC-based and utilize a generic user interface. advisors cannot customize the program's interface, functionality, or the methodologies used in performing the risk assessment, asset class mapping, optimization or investment product selection. Furthermore, most of these programs do not provide the advisor with the ability to directly collaborate online with clients, particularly through an interface that is dynamically customized by the advisor.

Further, most of the prior art, including some of the recent Web-based systems, are exclusively useful to users that reside in the U.S., and principally invest in US-based asset classes. From the identification of financial goals to the inputs for portfolio holdings, these financial advisory systems assume that all users have savings goals such as U.S.-based college and 401k-type retirement plans. Some of these systems, in fact, utilize a set of “core” asset classes, all of which are U.S. dollar-denominated securities and do not provide for non-dollar investments in the investment analysis and optimization. These prior art systems lack the mechanism to address the unique needs of investors and their advisors in marketplaces outside of the U.S. For such investors (i.e. those whose core holdings are non-U.S. asset classes) and their advisors, this US-centric focus and analysis is overly restrictive.

Another limitation of these programs is that many only provide generic asset class recommendations for the optimized portfolio, leaving it to the advisor to manually select the actual investment products to implement the suggested strategy. Typically, the advisor must utilize another program or data source to accurately suggest investment products that match the recommended asset class allocations.

Some prior art programs also require the user to provide estimates of the style characteristics pertaining to current portfolio holdings in order to “map” those holdings into asset classes. As should be appreciated, one of the problems with this approach is the time necessary for the user to perform such analysis, and the possibility for the user to mis-characterize a current holding that will lead to an erroneous result regarding the output produced, e.g. the financial plan.

Thus, there remains a need to provide advisors located anywhere in the world with a system and method to dynamically create a customized investment advisory application and interface that addresses the specific characteristics of the advisor's market including base currency, language, client risk profiling, portfolio inputs, asset classes, investment product options, tax regime, regulatory environment and pension system. More specifically, such a system is needed that addresses the unique investing'needs of all investors and not just those that reside and invest in the United States. Further, such a system should provide an integrated investment advisory tool through which an advisor can collaborate online. The present invention satisfies these and other needs.

### SUMMARY OF THE INVENTION

The present invention is a computer-implemented investment advisory system and method to assist a variety of financial intermediaries (i.e. investment advisors, securities brokers, web-based providers of financial advice, mutual fund companies, banks etc.), collectively referred to us “advisors,” in delivering personalized investment advisory services to individual and institutional investors.

A first embodiment of the present invention is an automated investment advisory system which incorporates an investment advisory method for users who desire an optimized investment portfolio. The method includes a number of steps, the first step involving the assessment of the user's risk profile. Once the system assesses the user's risk profile, the system maps the user's portfolio holdings into a set of asset classes. Based on a function of the mapped asset classes, the system returns an investment risk classification. Then, the system compares the user's investment risk classification with user's risk profile. Finally, the system recommends portfolio changes which correlate the user's investment risk and risk profile.

According to a second embodiment of the present invention, over a distributed computer network a user desiring an optimized investment portfolio and having a risk profile accesses a host server. The host server implements a method for constructing an optimized investment portfolio. First, the host server accepts an investment package from a station across a distributed computer network. Then, the host server processes the investment package to determine an optimized investment portfolio. Finally, the host server transmits a populated template to the station across the distributed computer network.

A third embodiment of the present invention comprises a software component in an automated investment advisory system where a user desiring an optimized investment portfolio is first presented with a questionnaire. The software component is comprised of many parts, one of which includes a risk engine. The risk engine generates a user risk profile using the questionnaire submitted by the user. The software component also comprises a database which is populated with portfolio holdings inputted directly by the user. A portfolio processor, another part of the software component, divides the database into distinct asset classes and generates an investment risk of the database. Last, the software component includes an optimization engine. The optimization engine generates an output by which the investment risk is correlated with the risk profile.

### DETAILED DESCRIPTION OF THE SUMMARY OF THE INVENTION

While the above represents the summary of the invention, the following describes with more particularity the preferred embodiments of the present invention. It is to be understood that the detailed description below is for purposes of illustration. The following detailed description does not limit the above summary of the invention.

According to one more particular aspect of the present invention, a mechanism is provided that allows the advisor to interactively customize the application. The advisor can select preferences for: (i) language (ii) base currency (iii) portfolio inputs for asset class mapping iv) methodology for asset class mapping v) asset classes to be included in the optimization calculation vi) risk and return dimensions for selected asset classes vii) correlation matrix for selected asset classes viii) specific investment products that represent selected asset classes ix) custodian/trading platform interface and x) integration with other applications used by the advisor. Further, the advisor can customize the interface to allow direct online client access to all or certain modules of the system. This customization allows the advisor to establish a personalized investment advisory system that suits his country, client base, business practices and local operating environment.

According to another more particular aspect of the present invention, a method is provided for advisors to deliver personalized investment advice to clients. An integrated process is provided whereby an advisor can interactively i) identify the client's risk rating through a questionnaire or goal analysis, and allow the advisor or client to select a different risk rating ii) map the client's current portfolio holdings to specific asset classes or, alternatively, if the client does not hold an investment portfolio, recommend pre-established portfolios for the client's risk rating iii) assign a risk rating and expected return to the current holdings based on historical data series for such asset classes and their respective correlations iii) compare the client risk rating to the risk level calculated for the current portfolio holdings iv) optimize the current portfolio given the client's risk rating, current holdings and asset classes selected by the advisor to be included in the optimization v) display the current portfolio and the optimized portfolio in a graphical output with the efficient frontier for the chosen asset classes and simultaneously display a pie graph indicating the recommended asset class allocation for the optimized portfolio vi) adjust a risk or return slider to visually indicate how movements along the efficient frontier affect recommended asset allocation strategy vii) select an optimized portfolio as the client's “baseline strategy,” and store this recommended allocation viii) select specific investment products for the recommended asset classes and ix) input a purchase and/or sales order to the advisor's custodian or trading platform to implement the strategy. Thereafter, the advisor can review the client's current portfolio holdings versus the baseline strategy as a portfolio management tool and “re-balance” the portfolio based on a selected level of deviation from the baseline strategy.

More specifically, the advisor, the client, or both complete an online risk questionnaire. Alternatively, a set of financial goals is established with the aid of on-line calculators. For example, the client can choose between a general savings goal, education savings, home purchase or other future need. In this example, the input values would be a financial goal, initial and periodic contributions and length of plan. The output value is the required portfolio return over the investment term to achieve that goal.

Through a graphical interface the output value either links into the creation of a portfolio (if the user does not have a current portfolio), or to a graphical interface to input his current portfolio. Prior art systems provide no mechanism for an investor that links a financial goal or risk rating to portfolio creation using an interactive process. Through a graphical interface the user inputs his current portfolio encompassing both dollar and non-dollar holdings. If desired, an on-line currency converter is provided to convert all holdings into U.S. dollar values.

If a portfolio already exists, the client's current portfolio holdings are then mapped into asset classes utilizing market capitalization, market and financial health (book-to-market ratios) criteria. For example, an input for the stock of Microsoft causes the system to calculate Microsoft's current market capitalization and book-to-market ratio. An internal rule engine generates an output value that characterizes the Microsoft holding as “large growth.” The system then conducts a lookup within the database of asset class returns and assign an expected return and risk to Microsoft based upon its asset class characterization. Utilizing this process for each of the client's current portfolio holdings the system produces an overall portfolio expected return and risk. The level of portfolio risk is compared to the risk profile of the client to ensure consistency. This process benefits a user with minimal, if any, investment knowledge. The system automatically maps the user's portfolio holdings into asset classes. Thus, a user need not personally know which asset classes his or her portfolio holdings belong to. The system shoulders this burden for the novice investor.

A mean-variance optimization is then performed on the current portfolio. Prior to performing the optimization calculations, the advisor can further customize the application with respect to the asset classes to include within the particular optimization; and, for the asset classes selected, constraints in the form of lower and upper bounds. While prior art envisions lower and upper bounds as a mechanism to control an optimization, the current invention uses the constraints to permit advisors to include desired asset classes within the output values. For example, while a Brazilian investor using prior art might be presented with a portfolio that does not include any Brazilian asset classes; the current invention however, would be customized to include local asset classes from a users home country.

Once the optimization is completed and the “baseline” strategy is selected, specific investment products that the client can use to implement the baseline strategy are displayed. The system presents the “baseline” strategy by displaying the projected optimized portfolio over a number of years (i.e. today, in 5 years, in 10 years and in 20 years). Although the advisor can pre-set in the set-up module the specific investment products to populate recommended asset classes, the system can also perform a search function, based on criteria established by the advisor (i.e. asset levels, expense ratios, domicile etc), to select investment products from a mutual fund database. This would be particularly useful to an advisor that uses an “open” product platform, selecting different mutual fund products for different clients.

Other objects and features of the present invention will become apparent from the following detailed description considered in conjunction with the accompanying drawings. It is to be understood, however, that the drawings are designed solely for the purpose of illustration and not as a definition of the invention, for which reference should be made to the appended claims.

### BRIEF DESCRIPTION OF THE DRAWINGS

The foregoing and other features of the present invention will be more readily apparent from the following detailed description and drawings of illustrative embodiments of the invention wherein like reference numbers refer to similar elements throughout the several views and in which:

FIG. 1 is a flowchart depicting a process for generating an optimized portfolio in accordance with a preferred embodiment of the present invention;

FIG. 2a is a perspective view of a network arrangement useful for implementing a preferred embodiment of the present invention;

FIG. 2b is a perspective view of a software integration from an Advisor's vantage point;

FIG. 3 is a perspective view of a software component for implementing a preferred embodiment of the present invention;

FIG. 4a is an exemplary questionnaire Web page in accordance with the preferred embodiment;

FIG. 4b is another Web page taken from the exemplary questionnaire such as shown in FIG. 4a;

FIG. 5 is an exemplary risk profile generated from input to Web pages such as shown in FIGS. 4a and 4b;

FIG. 6 is an exemplary portfolio holdings Web page;

FIG. 7 is an exemplary look-up feature Web page accessed from the portfolio holdings Web page of FIG. 6;

FIG. 8 is a further Web page accessed from the portfolio holdings Web page of FIG. 6;

FIG. 9a is an exemplary look-up feature Web page accessed from the portfolio holdings Web page of FIG. 6 which demonstrates an alternative look-up selection;

FIG. 9b is a further look-up feature Web page accessed from the Web page of FIG. 9a;

FIG. 10 is a further Web page accessed from FIG. 9a;

FIG. 11 is an exemplary portfolio holdings summary Web page;

FIG. 12 is an exemplary asset classes mapping Web page;

FIG. 13 is an exemplary asset class pie chart Web page;

FIG. 14 is an exemplary comparison summary Web page of investment risk versus risk profile;

FIG. 15 is an exemplary optimized investment portfolio template accessed from the Web page shown in FIG. 14;

FIG. 16 is an exemplary optimized investment portfolio pie chart Web page;

FIG. 17 is an exemplary value populated Web page of the optimized investment portfolio over a number of plurality of years;

FIG. 18 is an exemplary populated template which recommends portfolio changes; and

FIG. 19 is a exemplary financial advisor customization Web page.

### DETAILED DESCRIPTION OF THE PREFERRED EMBODIMENTS

By way of overview and introduction, a preferred embodiment of the present invention provides a software tool and technique for providing investment advisory services to users over a distributed computer network such as the Internet. In particular, a preferred embodiment of the present invention provides a software method for constructing an optimized investment portfolio based upon the user's risk profile and the user's current portfolio holdings. In a basic model, users answer a series of questions which enable the system to determine the user's risk profile. Once the system determines the user's risk profile, the system prompts the user to enter their portfolio holdings. The preferred embodiment of the present invention then maps these portfolio holdings automatically into asset classes. After the mapping, the system recommends portfolio changes using both the risk profile and the mapped asset classes.

The preferred embodiment of the present invention allows advisor customization. When determining risk profile, advisors choose language, base currency as well as the method of assessing the user's risk profile.In addition, advisors select the method for mapping portfolio holdings into asset classes and which portfolio holdings the method maps. When developing an optimized portfolio, advisors choose which asset classes to include, risk and return dimensions, correlation matrixes, and which investment products represent asset classes. Finally, when implementing a portfolio change, the preferred embodiment allows the advisor to integrate with the advisor's own trading platforms and investment advisory services.

The optimize online portfolio valuation is established by software using tables in a relational database and a software engine. The software accesses the relational database and pulls together disparate elements into an HTML page for presentation to a client machine corrected to a distributed computer network. Using a query-driven software engine, visitors can navigate a Web site with any requested information being dynamically rendered in response to user interactions (e.g., mouse clicks) within the investment advisory system. The software engine evaluates the user's current portfolio in relation to the optimized portfolio by using predefined criteria maintained in the database.

The query-driven software processor uses a series of tables which, in the presently preferred embodiment, are part of a relational database written in SQL7. The information stored in the tables populates one of several templates which define an HTML file. The software conveys the HTML file to a user at a client-side machine. As the user interacts with each page and makes an HTTP request to the server, a specific question is submitted to the server. This specific question can be included in a hidden field. This specific question causes one or more queries to be processed by the relational database. The relational database, in turn, responds to the specific question with a risk profile, an investment risk classification, a portfolio change recommendation which correlates the two, and follow-up questions to the specific question that was submitted. This information is combined with a selected HTML template using a scripting language such as JAVA Script, Perl or VBScript. The combined file is transmitted back to the client machine.

Preferably, the relational database runs on a dual or quad processor Pentium III computer with 2 GB of RAM and fault tolerant RAID hard disk storage of at least 80 GB. The software used with the relational database should be NT Server 4, SQL Server 7, with all the service packs.

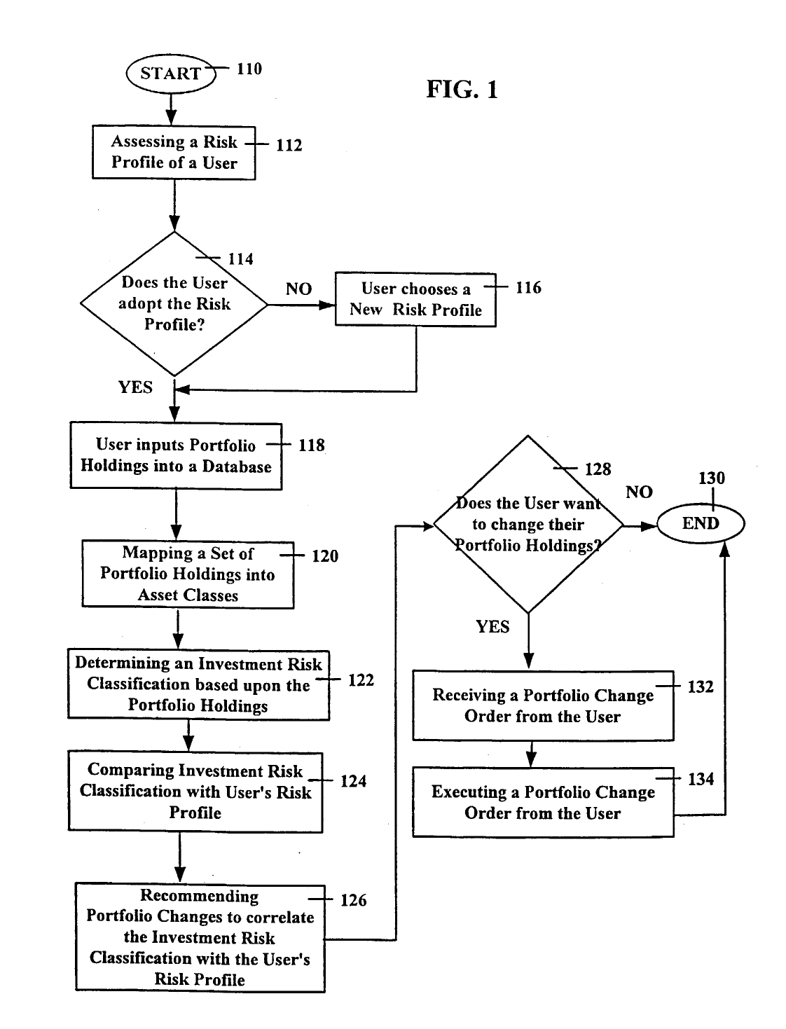

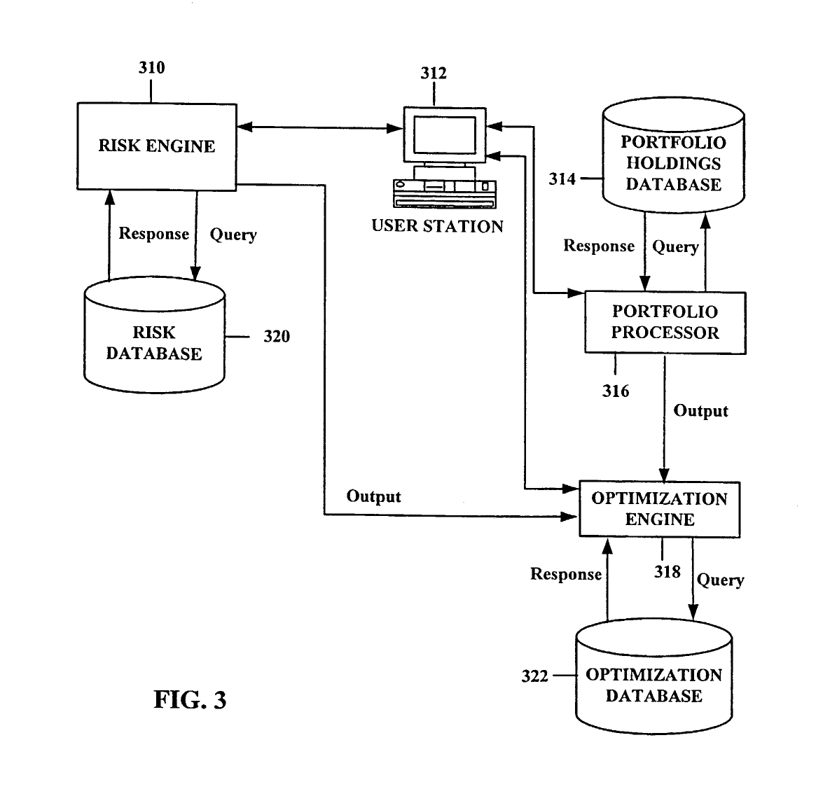

With reference now to FIG. 1, a flowchart depicting a process for generating an optimized portfolio in accordance with a preferred embodiment of the present invention is shown. At the start 110, the system assesses a risk profile of the user 112. The system assesses the risk profile 112 using answers the user submits from a questionnaire, as described below in connection with FIG. 3. The system then sends a risk profile assessment 112 to the user. The system then queries the user as to whether the user would like to adopt this risk profile 114. Should the user choose not to adopt the risk profile of the user, the user then chooses a different risk profile 116.

Once a risk profile has been adopted, the system attempts to determine the investment risk of the user's current portfolio. First, the system prompts the user to input portfolio holdings into a relational database 118. Once these portfolio holdings have been inputted 118, the system automatically maps the portfolio holdings into a set of asset classes 120. The user might be a novice investor who generally speaking, is unaware of the asset classes associated with his or her portfolio holdings. Thus, the system maps the portfolio holdings for the user by automatically characterizing the holdings into a variety of classes using a rule engine which processes objective data, such as market capitalization and book-to-market criteria. Once the system maps the portfolio holdings into asset classes 120, the system determines an investment risk classification based upon these portfolio holdings 122.

After both the risk profile and investment risk classification have been determined, the system can evaluate the information free of further input from the user. At this point, the system compares the investment risk classification with the user's risk profile 124. The system then suggests changes to the user's portfolio which better correlate the user's investment risk classification with the user's risk profile 126. Once the system generates a list of recommendations 126, the system presents the user with the opportunity to change his or her current portfolio holdings 128. Should the user decide not to change his or her current portfolio holdings, the user can then exit the system 130. On the other hand, because the system communicates with other financial intermediaries, users can execute changes to achieve a portfolio that corresponds with the recommendations 126 by placing portfolio change orders directly through the system.

If the user wishes to make a portfolio change, the user simply communicates a portfolio change order to the system. Upon receiving the user's portfolio change order at step 132, the appropriate financial custodian is instructed to execute the order, as indicated at step134.

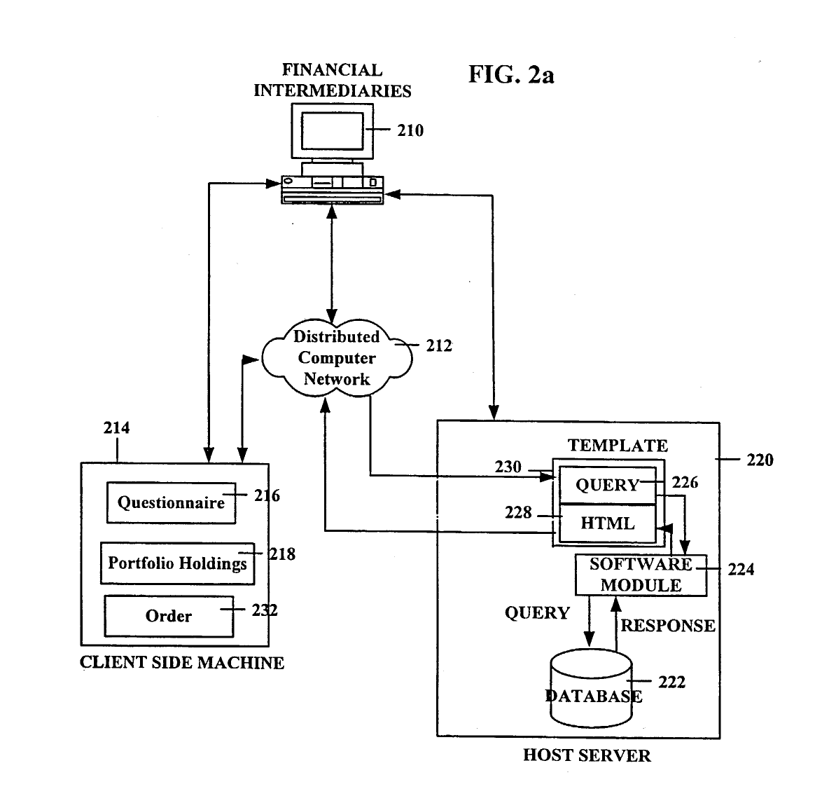

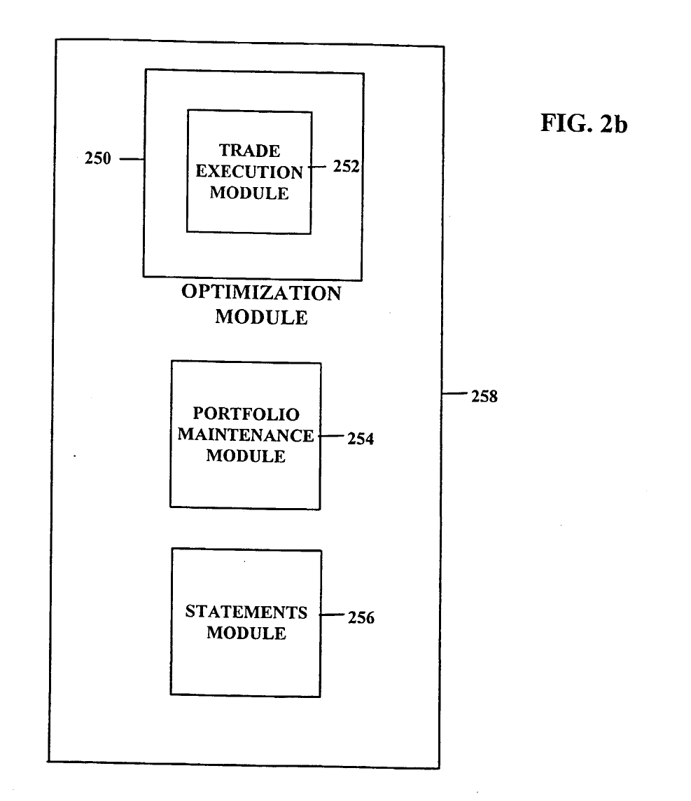

With reference now to FIG. 2a, a network arrangement of distributed computers is illustrated in which users at a client-side machine 214 operate a conventional Web browser such as those commercially available from Microsoft Corporation of Redmond, Wash. under the name Internet Explorer or Netscape Communications, Inc. of Mountain View, Calif. under the name Communicator. There can be a plurality of client-side machines 214 all connected through a distributed computer network 212 such as the Internet. A host server 220 is configured, in accordance with the preferred embodiment of the present invention, to implement a portfolio valuation using a relational database 222 and a software module 224 as described herein.

A user at the client-side machine 214 accesses the host server 220 by addressing the host server 220 in a conventional manner. For example, the user enters the Web site URL hosted by the host server 220 with a browser software package or the like. In response, the host server 220 provides over the distributed computer network 212 a Web page shown on the display screen at the client-side machine 214. The Web page includes, among other elements, a questionnaire 216 which prompts the user and guides him or her to further information available from the host server 220.

At the host server 220, a script or program retrieves specific template files 230 which contain both query statements 226 and an HTML form 228. The query statements 226 process the incoming answers contained in the questionnaire 216 and assess an appropriate risk profile 112 of the user. The host server 220 passes the query statements 226 to a software module 224 which translates the query statements 226 into a form suitable for the relational database 222. In the preferred embodiment, scripts generated by a commercially available software package such as Cold Fusion translate the query statements 226 into a form suitable for an SQL7 relational database 222. The relational database 222 responds to the query 226 in a conventional manner. The software module 224, in turn, populates the elements of an HTML form 228 with the data retrieved from the relational database 222. The software module 224 then conveys the populated HTML form 228 across the distributed computer network 212 to the user's client-side machine 214. The HTML form 228 is displayed in a conventional manner, such as, in the active window of the user's browser. The HTML form 228 conveys the user's risk profile to the user at the client side machine 214. In addition, the HTML form 228 queries the user at the client side machine 214 for the user's portfolio holdings 218.

With each hypertext link or form that the user inputs, the user conveys information which enables the host server 220 determine an optimized portfolio valuation. The process implemented between the client side machine 214 and the host server 220 for assessing risk profiles 112 is similar to the process implemented for determining investment risk classification 122.

At the client side machine 214, the user inputs portfolio holdings 218 and sends the portfolio holdings 218 across the distributed computer network 212 to the host server 220. At the host server 220, just as with the questionnaire 216, the portfolio holdings 218 retrieve specific template files 230 which contain both query statements 226 and an HTML form 228. The query statements 226 process the incoming portfolio holdings 218 to determine the appropriate investment risk classification 122 to forward to the relational database 222 for processing. The query statements 226 are then passed to a software module 224 which translates the query statements 226 into a form suitable for the relational database 222.

The relational database 222 responds to the query 226 just as before with the questionnaire 216 query 226. The software module 224, in turn, populates the elements of the HTML form 228 with the data retrieved from the relational database 222. The software module 224 then conveys the populated HTML form 228 across the distributed computer network 212 to the user's client-side machine 214. The HTML form 228 conveys the user's investment risk classification. The HTML form 228 also conveys a comparison of the user's investment risk and the user's risk profile 124 and a recommendation of how the user can change their portfolio to better correlate the user's investment risk classification with the user's risk profile 126.

The process to implement a portfolio change order 232 is similar to the above exchanges between the client side machine 214 and the host server 220. It should be noted that either the client side machine 214 or the host server 220 can at any time interact with financial intermediaries 210. The financial intermediaries 210 could be particularly useful when the user executes an order 232. Either the user at the client side machine 214 can implement the portfolio change order 232 directly or the user can implement the portfolio change order 232 through the host server 220. Financial intermediaries 210 include a number of investment advisory assistants. Some financial intermediaries 210 can include, but are not limited to investment advisors, securities brokers, web-based financial advisors, mutual fund companies, and banks. In addition, financial intermediaries 210 can include feeds from news services and live market data.

The presentation of Web pages is query driven, using the relational database 222 and a software module 224 to process responses and render the requested information. The response to a portfolio answer is provided to the client-side machine 214 in the form of a new Web page. The response defines the questions which will be presented to the user in that Web page. The response then defines the appropriate follow up Web pages to invoke.

With reference to FIG. 2b, a perspective view of a software integration from an Advisor's vantage point is demonstrated. Trade executions are generated in the trade execution module 252 based upon the fund selection routine within the optimization module 250. Upon selecting a fund, a seamless interface is provided to the advisor's trading platform or custodian. This is accomplished via a plug-in interface to the trading platform or custodian's site or through a daily batch upload of ASCII files which are then formatted within the appropriate trading system. This seamless integration can be seen in FIG. 2a where the host server 220 either directly or through the distributed computer network 212 communicates with the financial intermediaries 210. Such an interface linkage improves prior art systems that require printing of a trade ticket that is then forwarded to the trading platform or custodian.

At the time of acceptance by the client, the baseline strategy is captured in a database to be used in the portfolio maintenance module 254. Such dynamic linking of portfolio creation to portfolio measurement and maintenance is a clear improvement over prior art that requires a manual upload of portfolio data into portfolio maintenance and measurement systems. On a periodic basis as established by the advisor (i.e. quarterly or semi-annually), the system will notify the advisor of any deviations of the current portfolio from the baseline strategy, thereby prompting an action request.

Account statements are generated within the statements module 256 via batch receipt of ASCII files, or an interface, from the advisor's custodian(s). Prior art systems statements require the intermediary to manually load trade data in order to generate an account statement, or are provided directly from the fund vendor. In the case of statements provided from the fund vendor, only positions that are cleared through the vendor are contained in the statement. By virtue of plug-in to an array of vendors, a consolidated position of all holdings can now be produced in one statement. This enables the client to review all investment holdings from a single source.

The software 258 can logically be viewed as including the trade execution module 252, the portfolio maintenance module 254, and the statements module 256. These modules operate to implement the methods described herein.

With reference to FIG. 3, a perspective view of the software component for implementing a preferred embodiment of the present invention is demonstrated. This software component can reside locally on the user stations 312 or remotely and accessed across a distributed computer network 212 such as seen in FIG. 2. The software component preferably is updated with current market information using Internet updates, floppy disks, CD ROM disks or other methods commonly known in the art.

The software component facilitates the transmission of information between the user station 312 and various processors and engines. The user at the user station 312 submits various information queries to the processors and engines. Once the user station 312 transmits the information to the engines, the engines process the information queries into a form suitable for the particular database accessed. The database evaluates the information queries. Once evaluated, the engines send the evaluation to the user at the user station 312.

When assessing a user's risk profile 112, the software component contacts the risk engine 310 and the risk database 320. A risk profile is assessed by applying rules in the risk engine to the data in the risk database, and this assessment is made automatically on the basis of the data provided by the user. The user at the user station 312 submits a questionnaire 216. The questionnaire 216 queries the risk engine 310 for a risk profile. The risk engine 310 then translates the questionnaire 216 into a form suitable for the risk database 320. A rick profile is accessed by applying rules in the risk engine to the data in the risk database, and this assessment is made automatically on the basis of the data provided by the user. Once a risk profile has been assessed 112, the risk database 320 transmits the result to the risk engine 310. The risk engine 310 processes the result into a form suitable for the user and sends the result to the user station 312. The result may be presented as a text file, HTML page 228, a spreadsheet file or any other presentation file commonly known in the art. The user at the user station 312 may accept the risk profile sent or may further communicate with the risk engine 310 and risk database 320 to adopt a different risk profile.

When determining an investment risk classification 122, the software component contacts the portfolio processor 316. The user inputs portfolio holdings 218 directly into a database. The software component sends the portfolio information contained in the database to the portfolio processor 316. The portfolio processor 316 queries the portfolio holdings database 314. The portfolio holdings database 314 determines which asset classes are appropriately associated with the user's portfolio holdings 218 through a rules engine. The portfolio processor 316 receives the asset class information from the portfolio holdings database 314 and sends the asset class information to the user station 312.

Once the software component has assessed the user's risk profile 112 and has determined an investment risk classification 122, the optimization engine 318 is contacted to generate an output which correlates investment risk with risk profile. The software component sends the output of both the risk engine 310 and the portfolio processor 316 to the optimization engine 318 in order to compare the user's risk profile and investment risk classification in an effort to correlate the two. The outputs sent to the optimization engine 318 are sent to the optimization database 322. The optimization database 322 compares the outputs and then determines portfolio changes which would help to better correlate risk profile with investment risk. The optimization database 322 sends the response to the optimization engine 318 which parses the information into a form suitable for the user at the user station 312. Once the optimized portfolio information is of suitable form, the optimization engine 318 sends the optimized portfolio to the user at the user station 312.

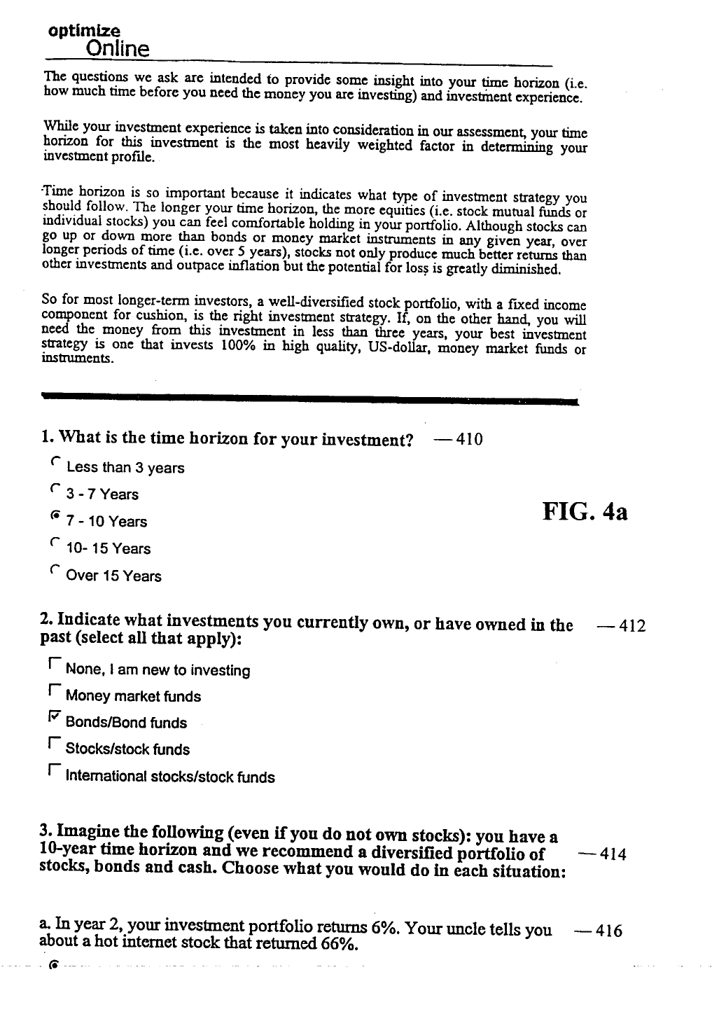

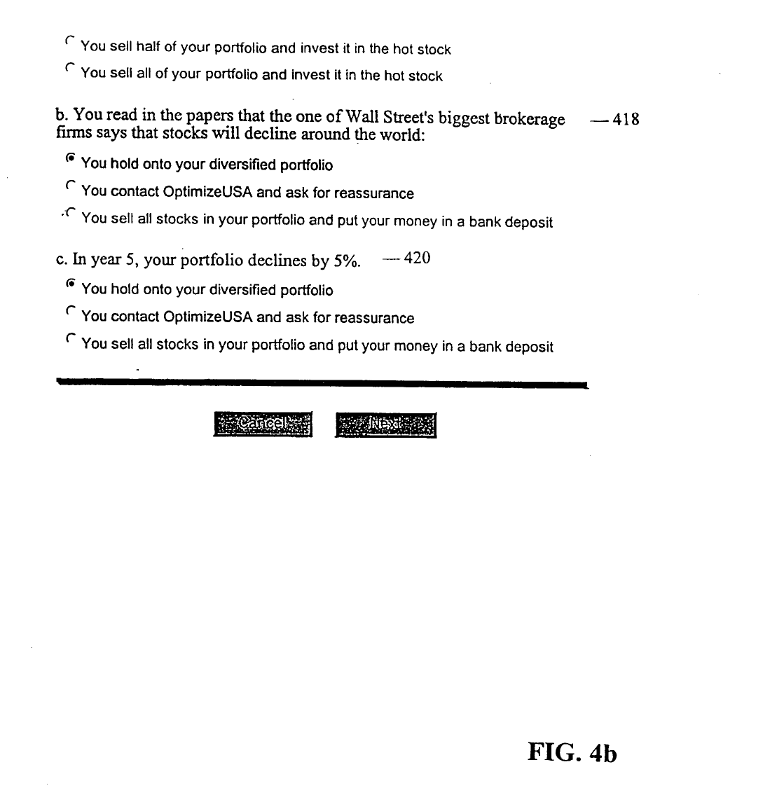

With reference to FIG. 4a and FIG. 4b, exemplary questionnaires 216 used in accordance with the preferred embodiment are demonstrated. Prior to the assessing step 112, the system sends HTML pages 228 comprising a questionnaire 216 to the user. The questionnaire 216 contains a list of questions 410, 412, 414, 416, 418 & 420. The questionnaire 216 answers are selectable by the user and are presented as submit buttons, hypertext links or some other selectable element as understood by those of skill in the art. Upon selecting an answer to the questions 410, 412, 414, 416, 418 & 420, an HTTP request is made to the server 220. The server 220 responds to the HTTP request with an assessment of a risk profile 112 of the user. To assess risk profile 112, the questionnaire 216 submitted asks questions relating to time horizon 410. In addition, the questionnaire 216 presents the user with a variety of hypothetical questions 416, 418 & 420. These hypothetical questions 416, 418, & 420 establish how the user reacts under various financial pressures. Question 412 establishes the investments the user currently is familiar with. Once the user selects answers to the questionnaire 216, a query 226 is sent to the risk engine 310 to assess a risk profile of the user 112. The questionnaire 216 as seen in FIG. 4a & FIG. 4b is an exemplary questionnaire 216. However, financial advisors can customize the questionnaire 216 to suit the advisor's individual customer needs.

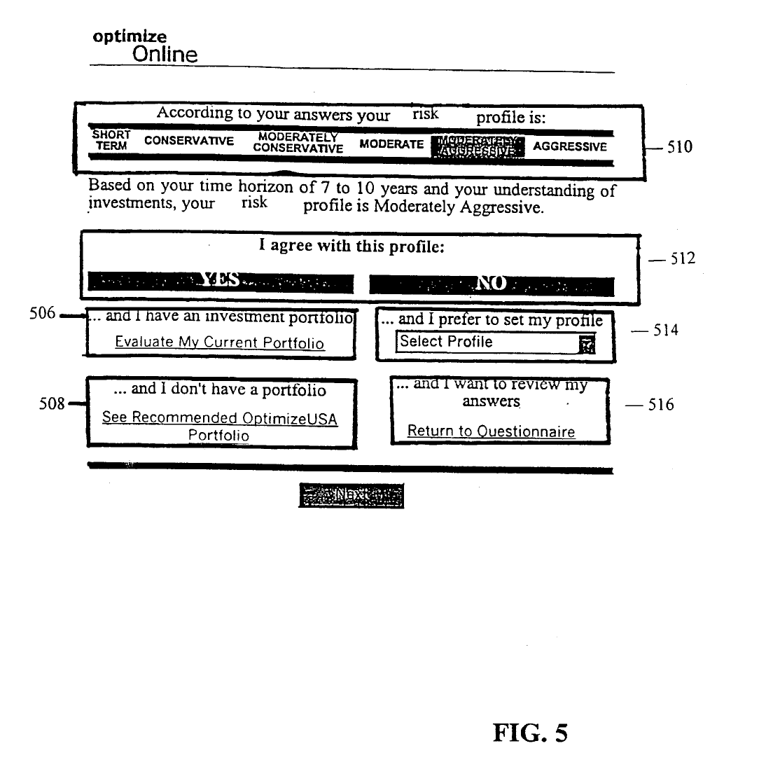

Once the user presses the NEXT button as seen in FIG. 4b, the user receives the exemplary risk profile 510 as seen in FIG. 5. The risk profile 510 is assessed by the risk database 320 in step 112. Note that in this case, the user's answers to the questionnaire 216 indicate a MODERATELY AGGRESSIVE risk profile 510. Again, this risk profile 510 can be customized to suit a particular financial advisor's needs. After presenting the user with his or her risk profile 510, the system asks the user whether or not the user wishes to adopt this profile 114. In FIG. 5, the user is presented with the choice of agreeing to the risk profile or not 512. Should the user agree to the risk profile, the user is then prompted to evaluate the user's current portfolio 506 or use a recommended portfolio 508. Should the user disagree on the system assessed risk profile 510, the user can either chose a risk profile 510 from a drop down menu 514 or review the questionnaire's 516 answers.

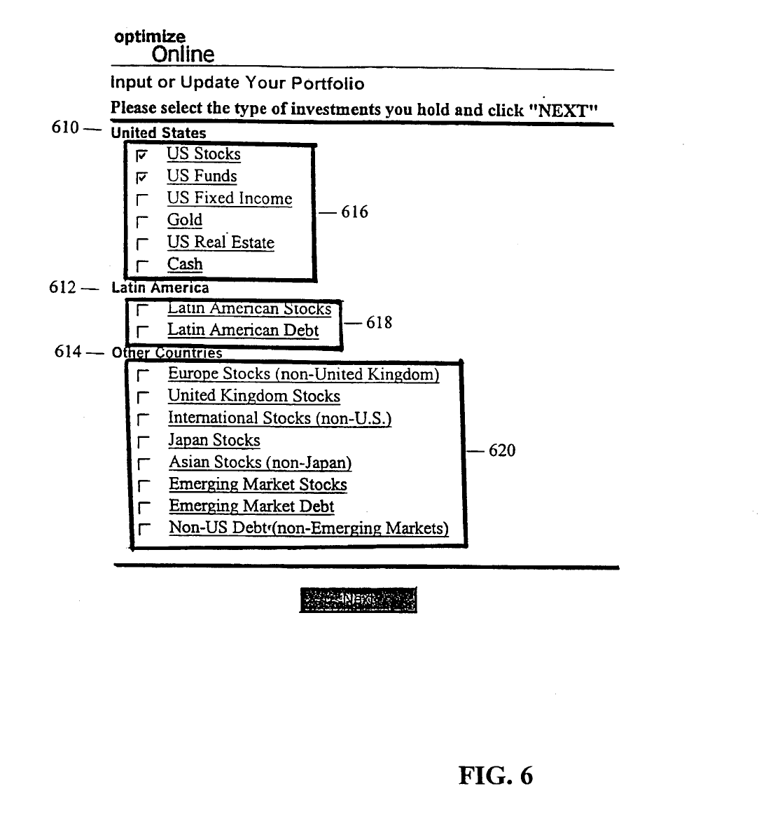

Once a risk profile 510 has been assessed 112, the NEXT button in FIG. 5 brings the user to FIG. 6 where the user directly inputs their portfolio holdings 218. Note that in FIG. 6 the investment are not solely United States investments 610 but include Latin American investments 612 and other countries 614 as well. This feature allows financial advisors who service investors outside of the United States to accurately represent their clients investments. As can be seen from the Other Country selections 620, the system evaluates investment risk using investments from Japan and the United Kingdom, to name just a few. Latin American stocks and debt are specifically recognized in the Latin America selections 618. This list of investments can be customized, expanded or minimized depending on a particular financial advisor's needs. The United States' selections 616 are fairly diversified, ranging from stocks to cash. Note that the user inputting their portfolio holdings 218 need only know the type of investment. Here, the user knew that US stocks and funds were the two investment types which he or she held. Both the US stocks and US funds boxes are checked in US selections 616.

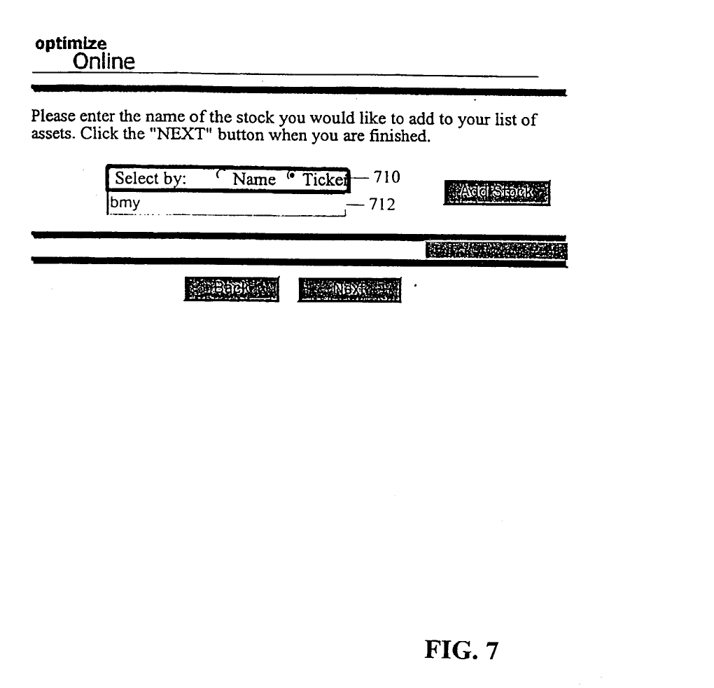

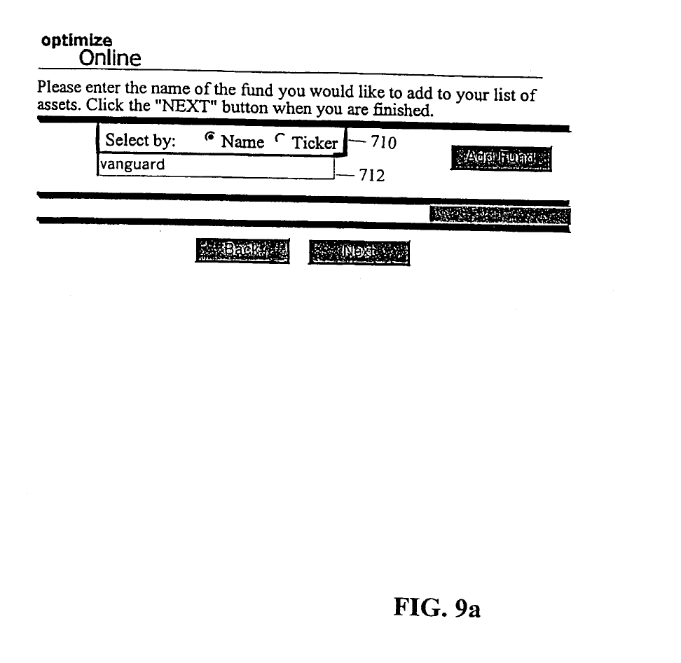

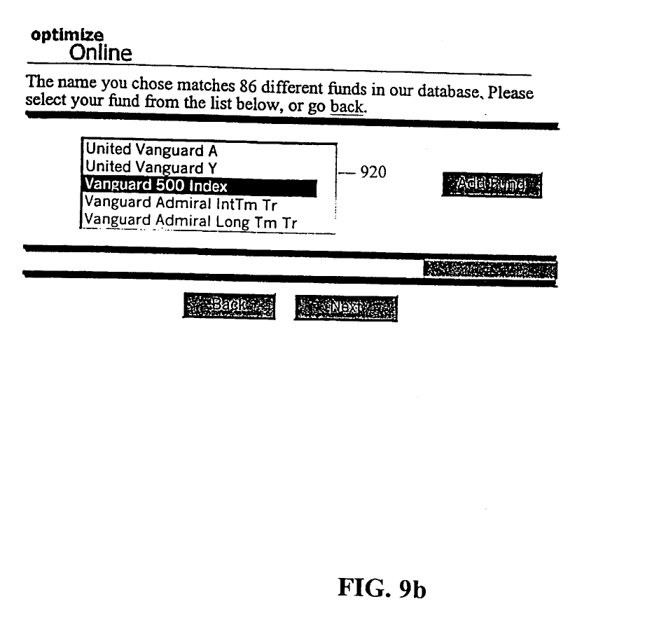

As soon as the user has identified his or her investment types, the user presses the NEXT button in FIG. 6 which brings the user to a series of look-up feature Web pages as seen in FIGS. 7, 8, 9a, 9b, & 10. The look-up feature Web pages aid the user in specifying the names of the investment types which the user identified in FIG. 6. In FIG. 6, the user identified holding the following investment types: US stocks and US funds. Now, the system queries the user for the name of the user's US stocks and US funds. Note that in FIGS. 7 & 8 the system asks the user about the US stock investments, while in FIGS. 9a, 9b & 10 the system asks the user about the US fund investments.

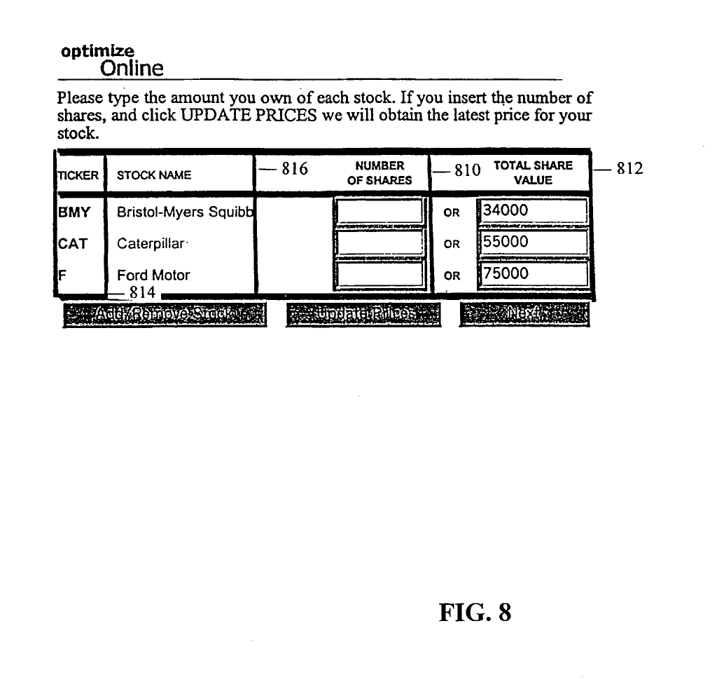

In FIGS. 7 & 8 the user inputs information about the user's US stocks. In FIG. 7, the system presents the user with a text box 712. In addition, the system presents the user with a “select by” choice 710. The “select by” choice 710 allows the user to identify their investments by either name or ticker. In this case, the user chose to identify the portfolio holding 218 by ticker. The system now knows that the information in the text box 712 is ticker based and not name based. Once the user hits the ADD STOCK button, the user is brought to FIG. 8 where the user can directly input the amount of the investment the user's owns. FIG. 8 identifies the US stock investment by ticker 814, name 816, number of shares 810, and total share value 812. Because in FIG. 7, the user added the stock with the ticker “bmy,” “bmy” is listed in the ticker box 814, the stock is named Bristol-Myers Squibb in the name box 816, and the total share value is identified as 34000 in the total share value box 812.

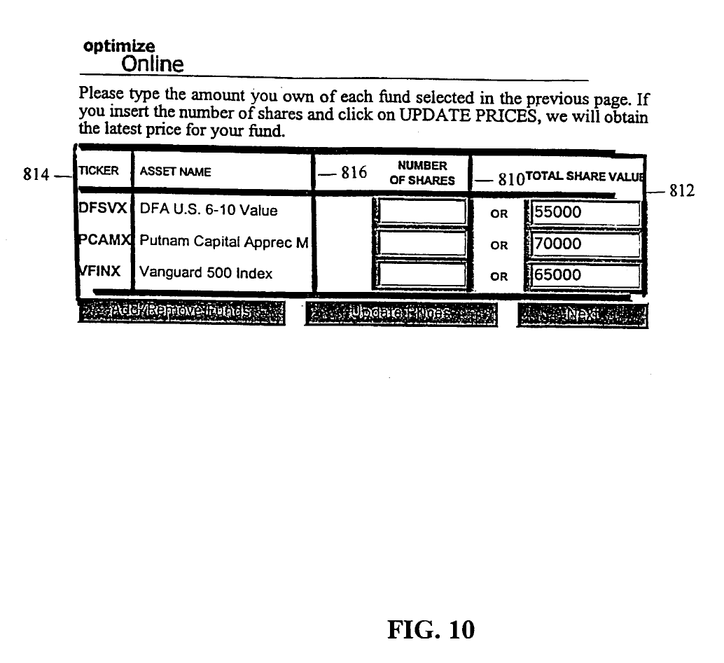

In FIGS. 9a, 9b, & 10, the user inputs information about the user's US funds. Note that in FIG. 9a rather than identifying the asset by ticker as was the case in FIG. 7, here an asset was identified by name. In the text box 712, the user submits the name “vanguard.” In the “select by” box 710, the user selected Name. Upon pressing the ADD FUND button, the system sends the user to FIG. 9b, where the system further queries the user for the specific US fund name. As demonstrated in FIG. 9b, the name “vanguard” submitted in FIG. 9a is used to identify a number of US funds. The user selects the Vanguard 500 Index from the scroll box 920 in FIG. 9b. Once the user names each US fund, the system prompts the user for the amount of asset the user owns. As was the case with FIG. 8, in FIG. 10 the assets are identified by ticker 814, name 816, the number of shares 810 and the total share value 812. Here, the user owns 65000 of the Vanguard 500 Index fund which the user identified in FIGS. 9a & 9b.

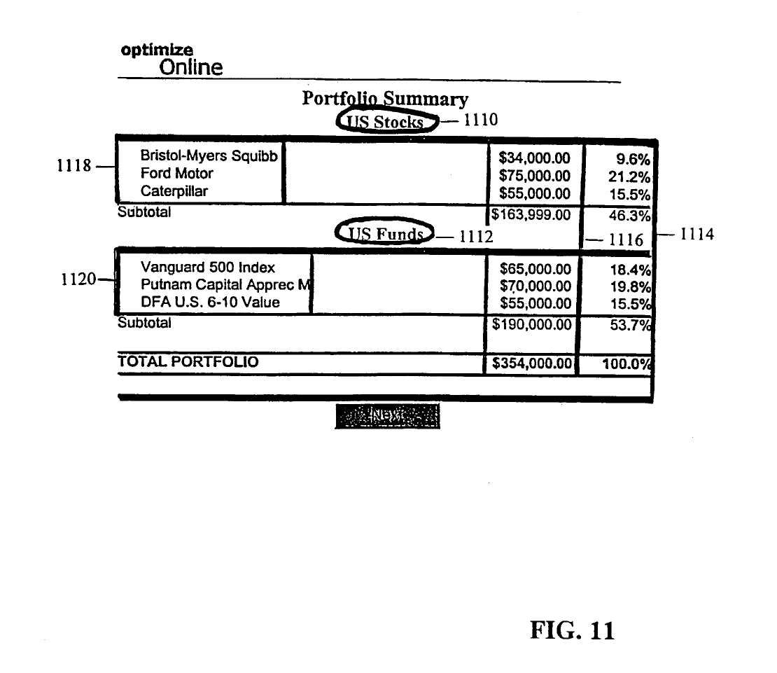

With reference now to FIG. 11, a portfolio holdings summary page is displayed. Note that the portfolio is divided by US stocks 1110 and US Funds 1112, the two investment types the user identified in FIG. 6. Each US stock is identified by stock name 1118, total stock share value 1116 and stock percentage of the user's current portfolio 1114. Similarly, each US fund is identified by fund name 1120, total fund share value 1116, and fund percentage of the user's current portfolio 1114. The Bristol-Myers Squibb stock added in FIG. 7 maintains 9.6% of the user's total portfolio, while the Vanguard 500 Index fund added in FIG. 9b maintains 18.4% of the user's total portfolio.

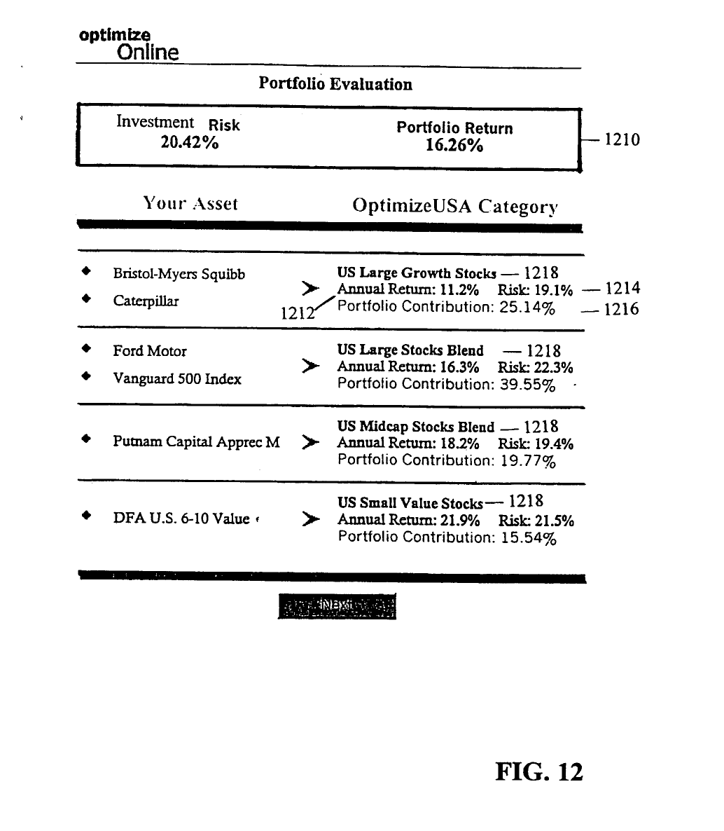

FIG. 12 is an exemplary asset classes Web page which the user accesses by pressing the NEXT button in FIG. 11. In FIG. 12, the system has mapped a set of portfolio holdings into asset classes 120. At this point, the system has determined an investment risk of the user's current portfolio and a portfolio return 1210. In FIG. 12, the system identifies four asset classes 1218 which the user's investments belong to. The four asset classes 1218 identified in FIG. 12 are: US Large Growth Stocks, US Large Stocks Blend, US Midcap Stocks Blend, and US Small Value Stocks. The system does the thinking for the novice investor. The novice investor need not know that his or her Bristol-Myers stock is US Large Growth and his or her Vanguard 500 fund is a US Large Stocks Blend. Besides mapping into asset classes 1218, the system determines the annual return of each asset class 1212, the risk 1214, and the total portfolio contribution 1216.

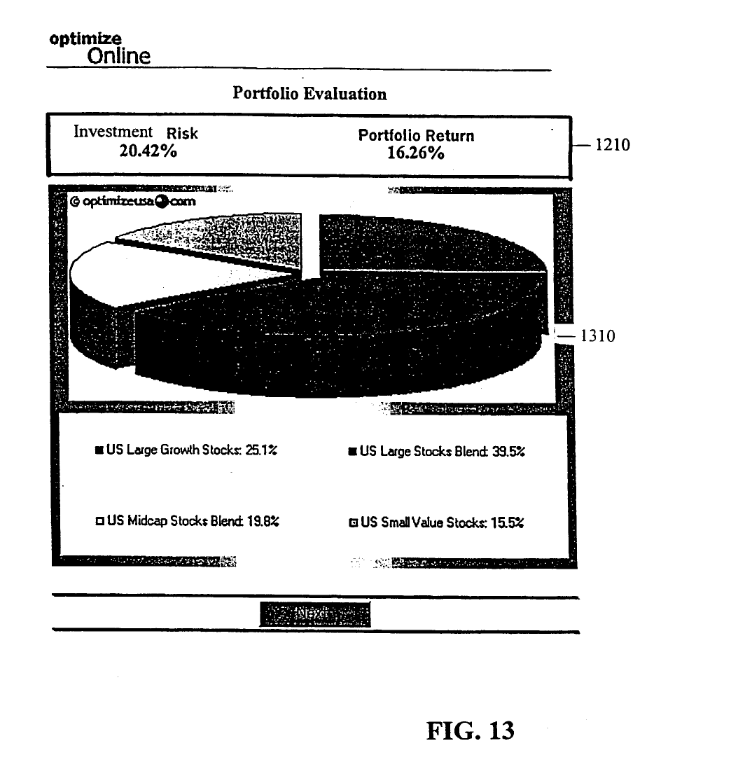

FIG. 13 accessed from the NEXT button in FIG. 12 presents an asset class pie chart. Here, the user still receives the information regarding the user's investment risk and portfolio return 1210, but in addition the user receives a pictorial representation or his or her entire portfolio 1310. The portfolio is represented not by individual investment holdings, but by asset classes 1218.

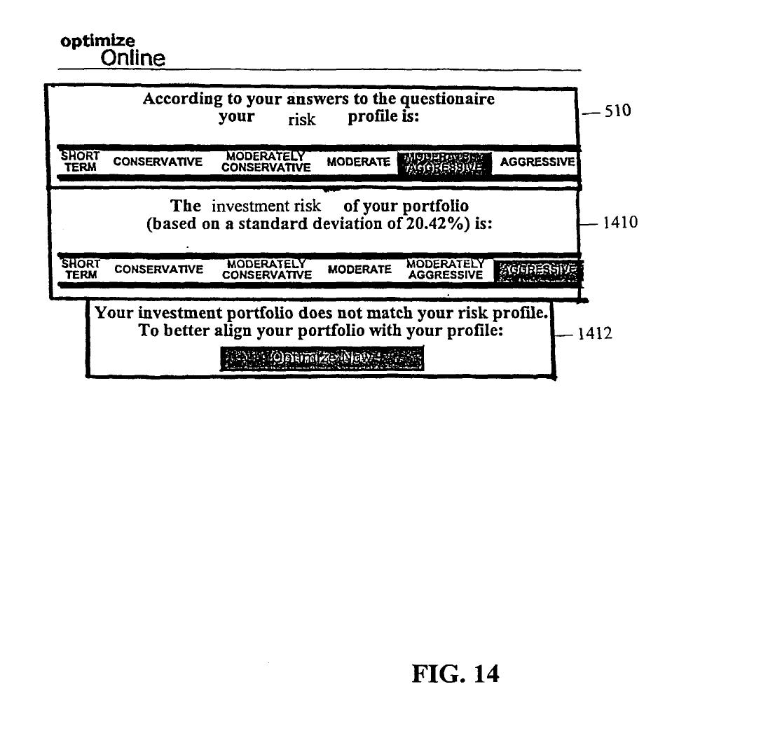

Following the pictorial presentation of the user's portfolio 1310, the user is shown FIG. 14, a comparison summary web page of the user's risk profile 510 and the user's investment risk. As seen in FIG. 5, the user is once again reminded of their risk profile 510. However, now in addition to risk profile 510, the user is presented with an investment risk 1410 classification. The user can compare their risk profile 510 with their investment risk 1410 classification and then decide if he or she wants to OPTIMIZE their current portfolio. Here the user's risk profile 510 is MODERATELY AGGRESSIVE, but according to the user's portfolio holdings 218, the user's investment risk is AGGRESSIVE. By pressing the OPTIMIZE NOW button 1412, the user aligns his or her risk profile 510 with his or her investment risk 1410 classification.

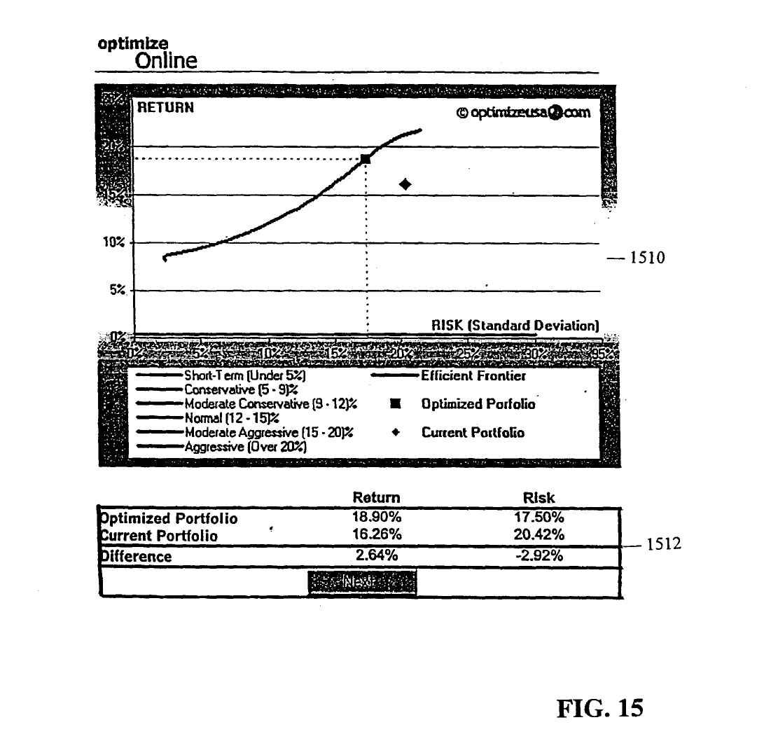

Upon pressing the OPTIMIZE NOW button in FIG. 14, the user is taken to FIG. 15 which is an exemplary optimized investment portfolio template 230. Here the user looking at the graph 1510 can visually compare the optimized portfolio with the user's current portfolio. In addition to the graph 1510, the user can also evaluate the optimized portfolio in light of the current portfolio by comparing return and risk statistics 1512.

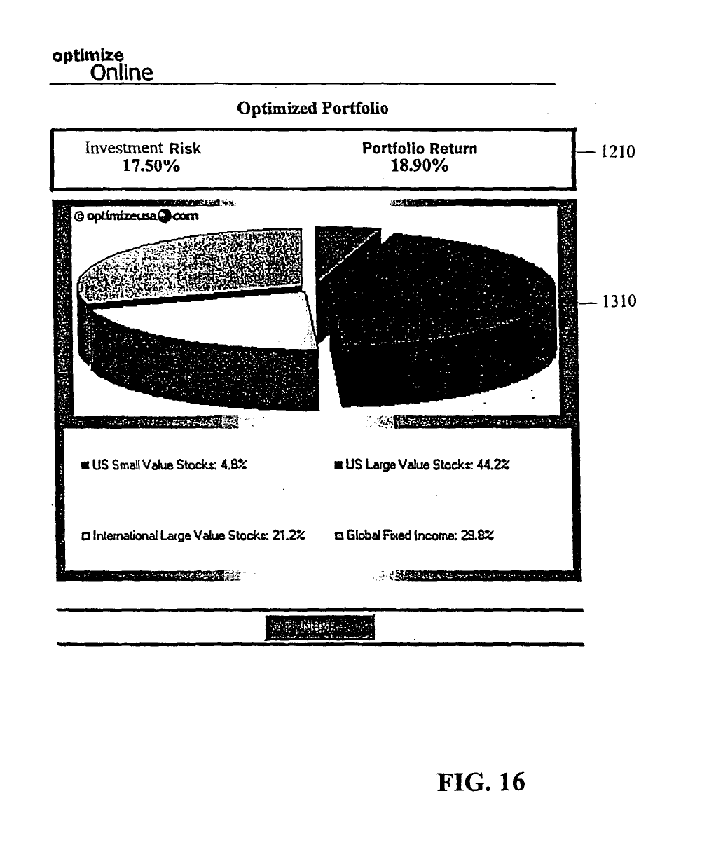

The NEXT button in FIG. 15 takes the user to FIG. 16. Similar to the asset class pie chart in FIG. 13, the user sees an asset class pie chart 1310 again. However, the asset class pie chart in FIG. 16 displays the optimized portfolio's asset class holdings and not the user's current asset class holdings as was seen in FIG. 13. The optimized portfolio's investment risk and portfolio return 1210 are also presented.

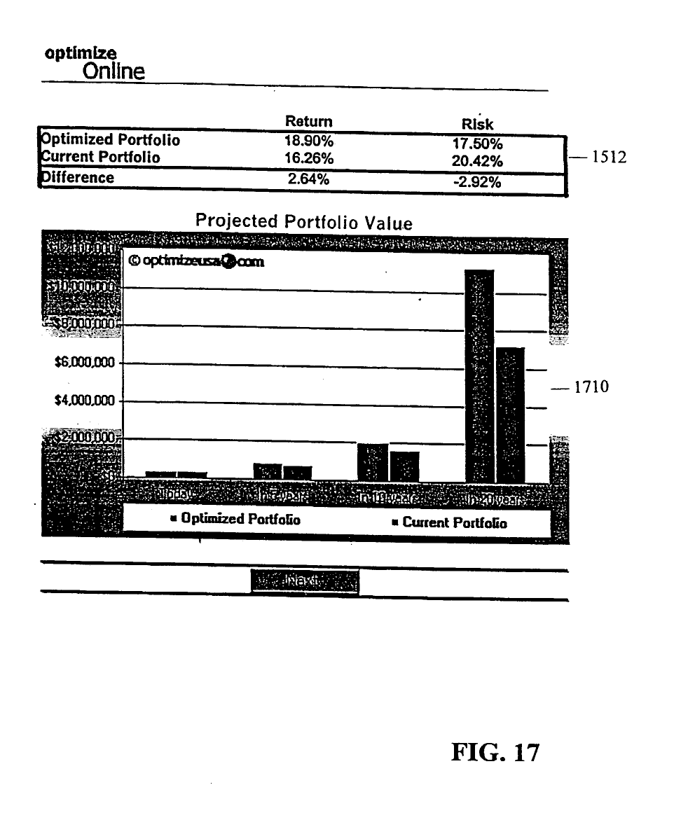

In FIG. 17, accessed by pressing NEXT in FIG. 16, an exemplary value populated template 230 of the optimized investment portfolio projected over a number of years is displayed. The time chart 1710 depicts the value of both the current portfolio and the optimized portfolio from today, five years from now, ten years from now, and twenty years from now. In addition, the risk and return statistics of the current portfolio and the optimized portfolio seen in FIG. 15 are once again displayed.

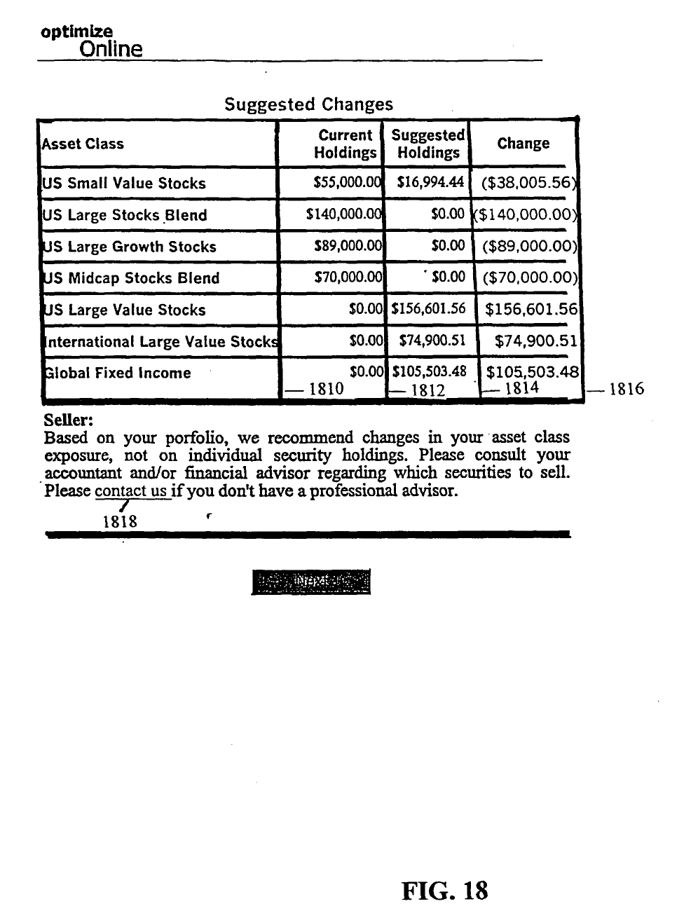

FIG. 18 is an exemplary populated template 230 recommending specific portfolio changes which would turn the user's current portfolio into an optimized portfolio. A list of preferred asset classes 1810 is presented as well as a list of current holdings 1812 and a list of suggested holdings 1814. The chart also indicates the portfolio change amount 1816. Should the user wish to order 232 portfolio changes the user is presented with a hypertext link 1818 which would connect the user to the appropriate financial custodian.

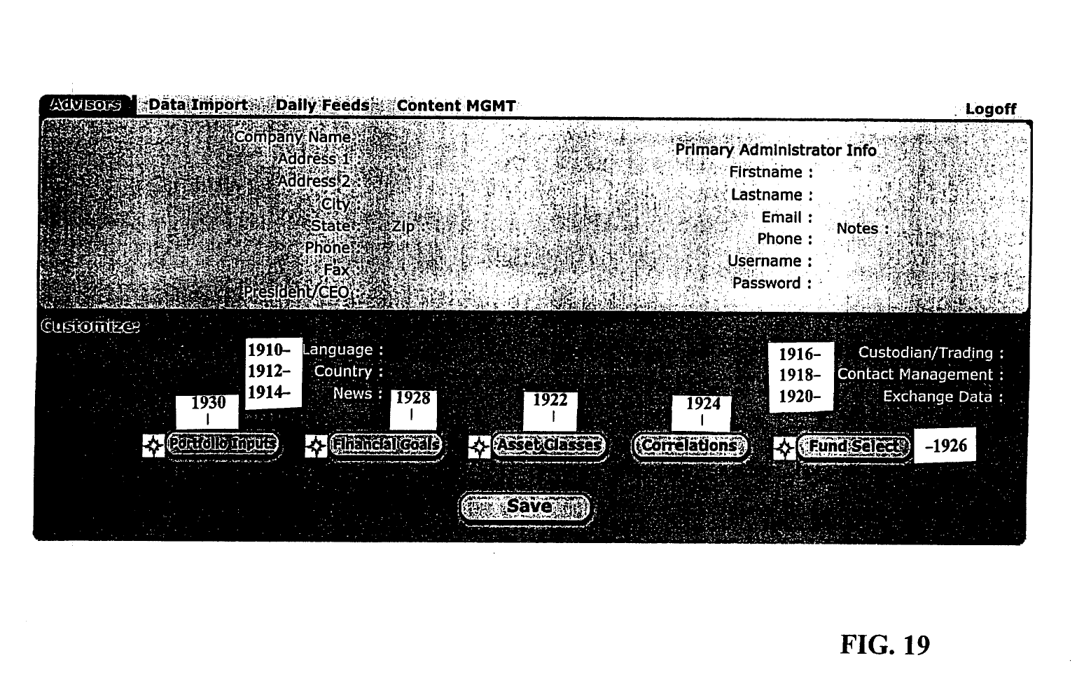

With reference now to FIG. 19, FIG. 19 demonstrates an exemplary financial advisor customization Web page. As mentioned herein, financial advisors can customize implementations of the investment advisory method. As seen in FIG. 19, advisors can customize the display language 1910 (i.e. English, Spanish, Italian, etc.) as well as country 1912 preference. A news source 1914 is an additional source of financial advisor customization. While the questionnaire 216 as seen in FIGS. 4a & 4b demonstrates one method for assessing a client's risk profile 510, other questions and methods can be used. A financial advisor by pressing the FINANCIAL GOALS 1928 button can customize the method for assessing a client's risk profile 510. The type of eligible portfolio holdings 218 for the portfolio mapping can also be customized by pressing the PORTFOLIO INPUTS 1930 button. Asset classes to be used for optimization purposes are customizable by pressing the ASSET CLASSES 1922 button. In addition, the correlation matrix 1924 used to choose asset classes as well as the investment products 1926 associated with specific asset classes are features which financial advisors can adapt to their individual needs. Naturally, trading platforms 1916, management contacts 1918 and data exchange platforms 1920 can also be uniquely specified by individual financial advisors.

While the present invention has been described with respect to a particularly preferred embodiment, the invention is susceptible to implementation in other ways that are within the spirit of the invention which is defined in terms of the recitations of the appended claims and equivalents thereof.

What is claimed is:

1. In an automated investment advisory system, an investment advisory method for a user desiring an optimized investment portfolio, comprising the steps of:
assessing a risk profile of the user;
mapping automatically a set of portfolio holdings of the user into a set of asset classes;
determining an investment risk classification as a function of the mapped asset classes;
comparing the investment risk classification with the user's risk profile; and
recommending portfolio changes to correlate the investment risk classification with the user's risk profile.

2. An investment advisory method as in claim 1, further comprising the step of:
receiving a portfolio change order from the user; and
executing the portfolio change order received from the user.

3. An investment advisory method as in claim 1, wherein the method is executed across a distributed computer network.

4. An investment advisory method as in claim 1, wherein the assessing step includes parsing a questionnaire completed by the user.

5. An investment advisory method as in claim 1, wherein the assessing step parses the questionnaire as a function of a time horizon of the user.

6. An investment advisory method as in claim 1, wherein the mapping step divides the holdings as a function of country association.

7. An investment advisory method as in claim 1, wherein the determining step automatically chooses the risk classification of the user.

8. An investment advisory method as in claim 1, wherein the assessing step accepts the risk profile chosen by the user.

9. An investment advisory method as in claim 1, wherein the assessing step chooses the risk profile of the user.

10. An investment advisory method as in claim 2, wherein a financial advisor customizes an implementation of the investment advisory method.

11. An investment advisory method as in claim 10, wherein the customized implementation is selected from the group of: method for asset class mapping, method for classifying investment risk, method for correlating asset classes and method for optimizing.

12. In a distributed computer network in which a user desiring an optimized investment portfolio and having a risk profile accesses a host server, a method for constructing an optimized investment portfolio at the host server comprising the steps of:
accepting from a station across a distributed computer network an investment package;
processing the investment package to determine an optimized investment portfolio; and
transmitting a populated template representing the optimized investment portfolio to the station across the distributed computer network.

13. A method for constructing an optimized investment portfolio at a host server as in claim 12 wherein the processing step further includes the steps of:
assessing a risk profile from the investment package;
determining an investment risk classification from the investment package; and
recommending a set of portfolio changes to correlate the investment risk classification with the user's risk profile.

14. In an automated investment advisory system where a user desiring an optimized investment portfolio is presented with a questionnaire, a software component comprising:
a risk engine which generates a risk profile of the user using the questionnaire submitted by the user;
a database populated with portfolio holdings inputted directly by the user;
a portfolio processor which divides the database into distinct asset classes and generates an investment risk of the database; and
an optimization engine which generates an output by which the investment risk is correlated with the risk profile.

15. A software component as in claim 14, wherein the output includes the optimized investment portfolio.

16. A software component as in claim 14, wherein the optimized investment portfolio comprises proposed changes to the user's portfolio holdings.

17. A software component as in claim 14, wherein the output estimates a value of the optimized investment portfolio over a plurality of years.

18. A software component as in claim 14, wherein the database includes a look-up feature which facilitates populating the database with an accurate representation of the user's portfolio holdings.

19. A software component as in claim 18, wherein the look-up feature is ticker based.

20. A software component as in claim 18, wherein the look-up feature is name based.

21. A software component as in claim 14, wherein the system is located across a distributed computer network.

22. A software component as in claim 14, wherein the asset classes are United States-centric.

23. A software component as in claim 14, wherein the asset classes are international.
